(19) United States
(12) Patent Application Publication
(10) Pub. No.: US 2015/0367513 A1
(43) Pub. Date: Dec. 24, 2015

(54) SYSTEM AND METHOD FOR COLLECTING AND PROCESSING DATA AND FOR UTILIZING ROBOTIC AND/OR HUMAN RESOURCES

(71) Applicant: RoboteX Inc., Sunnyvale, CA (US)

(72) Inventors: Adam M. GETTINGS, Red Wing, MN (US); Andrew G. STEVENS, Palo Alto, CA (US)

(73) Assignee: ROBOTEX INC., Sunnyvale, CA (US)

(21) Appl. No.: 14/842,749

(22) Filed: Sep. 1, 2015

Related U.S. Application Data
(63) Continuation of application No. PCT/US2014/021391, filed on Mar. 6, 2014.
(60) Provisional application No. 61/773,759, filed on Mar. 6, 2013.

(51) Int. Cl. B25J 9/16; B25J 9/00

(52) U.S. Cl. CPC B25J 9/1664; B25J 9/0084

(57) ABSTRACT

A roaming sensor system is described herein. The system can have one or more robots. The system can collect and process data efficiently and utilize robotic and/or human resources effectively by scheduling priorities of robot and/or human tasks, allocating the use of robot and/or human resources, and optimizing robot and/or human routes across the infrastructure of an organization.

### CROSS-REFERENCE TO RELATED APPLICATION

This application is a continuation of international Application No. PCT/US2014/021391 filed Mar. 6, 2014 which claims priority to U.S. Provisional Application No. 61/773,759 filed Mar. 6, 2013, which are incorporated by reference herein in their entirety.

### BACKGROUND

There are a number of challenges in operating a robot in conjunction with humans and buildings/environments. When multiple robots are available, the challenges can multiply significantly. Thus, there is a need in the robotics field to create a new system for managing robots and their interactions with buildings/environments and humans. This invention provides such a new system and method for collecting and processing data efficiently and utilizing robotic and/or human resources effectively.

Security, maintenance, and operations staff have a large amount of territory to cover and large amounts of data to process when coordinating humans, robots, computer systems, and/or sensors in a building, worksite, campus, or other large environment. There are a variety of sensors, navigation devices, mapping devices, and other data collection and/or task performing devices that can generate large amounts of data. This information can be recorded, stored, processed, filtered, and/or otherwise utilized in real-time or with post-processing. Allocating robotic and/or human resources in response to collected and/or processed data can be complex. Effectively utilizing resources, prioritizing tasks, and allocating routes (possibly in real-time) while performing operational tasks, maintenance tasks, security tasks, safety tasks, and/or any other suitable tasks can be challenging.

### SUMMARY OF THE INVENTION

A system is described herein that can collect and process data and utilize robotic and/or human resources by scheduling priorities of robot and/or human tasks, allocating the use of robot and/or human resources, and optimizing robot and/or human routes across the infrastructure of an organization. The system can have a roaming sensor system.

### BRIEF DESCRIPTION OF THE FIGURES

FIG. 1 is a schematic diagram of a variation of an environment having a roaming sensor system.

FIG. 2a is a diagram of a variation of an allocation of functionalities or division of tasks between three robots: Robot A, Robot B, and Robot C.

FIG. 2b is a diagram of a variation of an allocation of functionalities or division of tasks between three robots: Robot A, Robot B, and Robot C.

FIGS. 3a through 3c are diagrams of variations of allocations of time between tasks for a cleaning/compliance robot.

FIG. 4a is a schematic diagram of a variation of process flow for an interrupt handler.

FIGS. 4b through 4d are tables of variations of interrupt signals with a priority score.

FIGS. 5a through 5c illustrate variations of routes or paths on a map of an environment for a wear-leveling selection process for the robot route.

FIGS. 6a through 6d illustrate variations of routes or paths on a map of an environment for a randomized selection process for the robot route.

FIG. 7 illustrates a variation of a route or path on a map of an environment for a flanking selection process for the robot route.

FIG. 8 illustrates a variation of a route or path on a map of an environment for a high-alert area or zone targeting selection process for the robot route.

FIG. 9 illustrates a variation of a route or path on a map of an environment for a selection process for allocating the route across multiple robots.

FIG. 10 illustrates a variation of a building equipped with sensors and an example of a robot equipped with sensors.

FIG. 11 illustrates a variation of a building equipped with robot navigation beacons.

### DETAILED DESCRIPTION

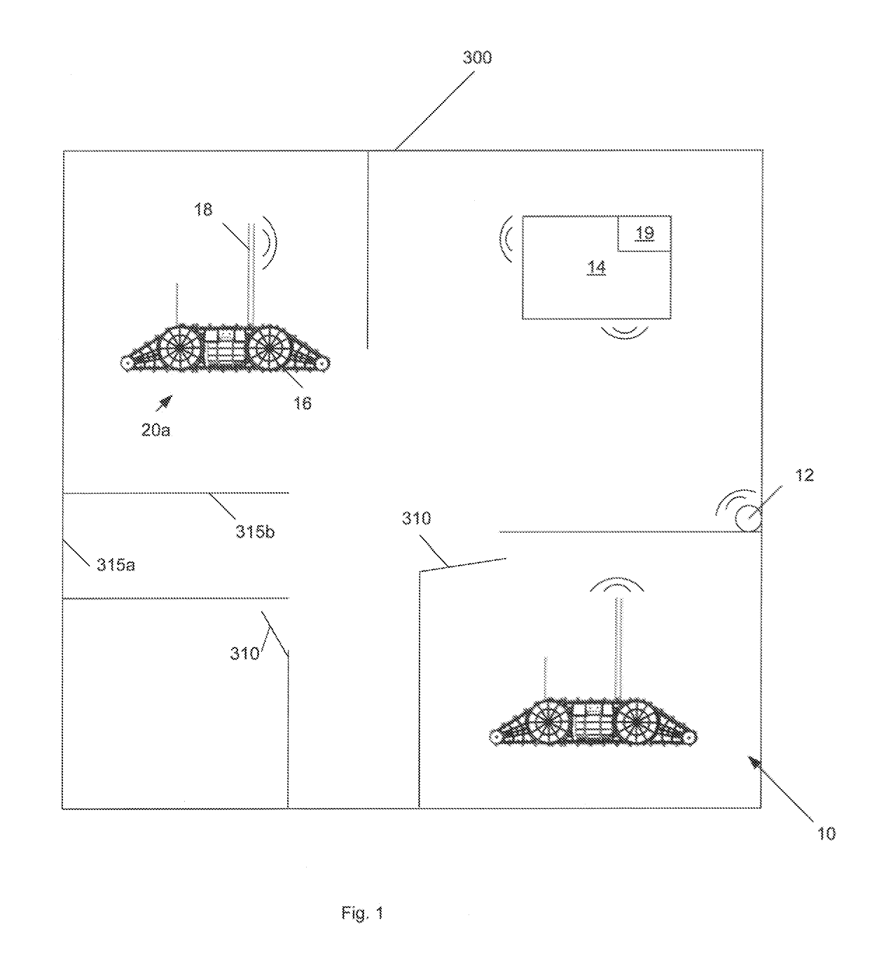

FIG. 1 illustrates that a roaming sensor system 10 can be located in and operate in an environment 300, such as a building (as shown), campus of one or more indoor and outdoor areas, yard, transportation construct (e.g., road, bridge, tunnel, airport tarmac, train platform, seaport), or combinations thereof. The environment 300 can have exterior and interior walls 315a and 315b and doors 310. The environment 300 can have one or more sensors 12. The sensors 12 can be mounted and fixed to the ceilings, walls, floor, ground, windows, electrical outlets, data outlets (e.g., ethernet ports, wall-mounted audio ports), fixtures, movable objects/chattel (e.g., furniture, computers, appliances such as refrigerators, livestock), unmounted, unfixed, or combinations thereof.

The roaming sensor system 10 can have a server 14, a first robot 20a, a second robot 20b, and more robots (not shown). The robots 20 can be mobile and can have one or more mobility elements 16, such as tracks, arms, wheels, or combinations thereof. The robots 20 can have one or more microprocessors and memory (e.g., solid-state/flash memory, one or more hard drives, combinations thereof). The robots can have robot antennas 18 that can transmit and receive data and/or power over a wireless communication and/or power network. The robots 20 can broadcast and/or receive wired and/or wireless data or power to and/or from the server 14, sensors 12, other robots 20, or combinations thereof (e.g., the aforementioned elements can be in a communication and/or power network). The robots 20 can have any of the elements described in U.S. Pat. No. 8,100,205, issued 24 Jan. 2012, or U.S. patent application Ser. No. 13/740,928, filed 14 Jan. 2013, which are incorporated by reference herein in their entireties.

The server 14 can have one or more microprocessors and memory 19 (e.g., solid-state/flash memory, one or more hard drives, combinations thereof). The server 19 can represent one or more local (i.e., in the environment) or remotely (i.e., outside of the environment) located servers, processors, memory, or combinations thereof. The server and/or robot microprocessors can act in collaboration as a set (e.g., distributing processor tasks) or independently to control the robots. The server can have a networking device in communication with the robots, or other networked elements in the environment or on a WAN outside of the environment or the Internet.

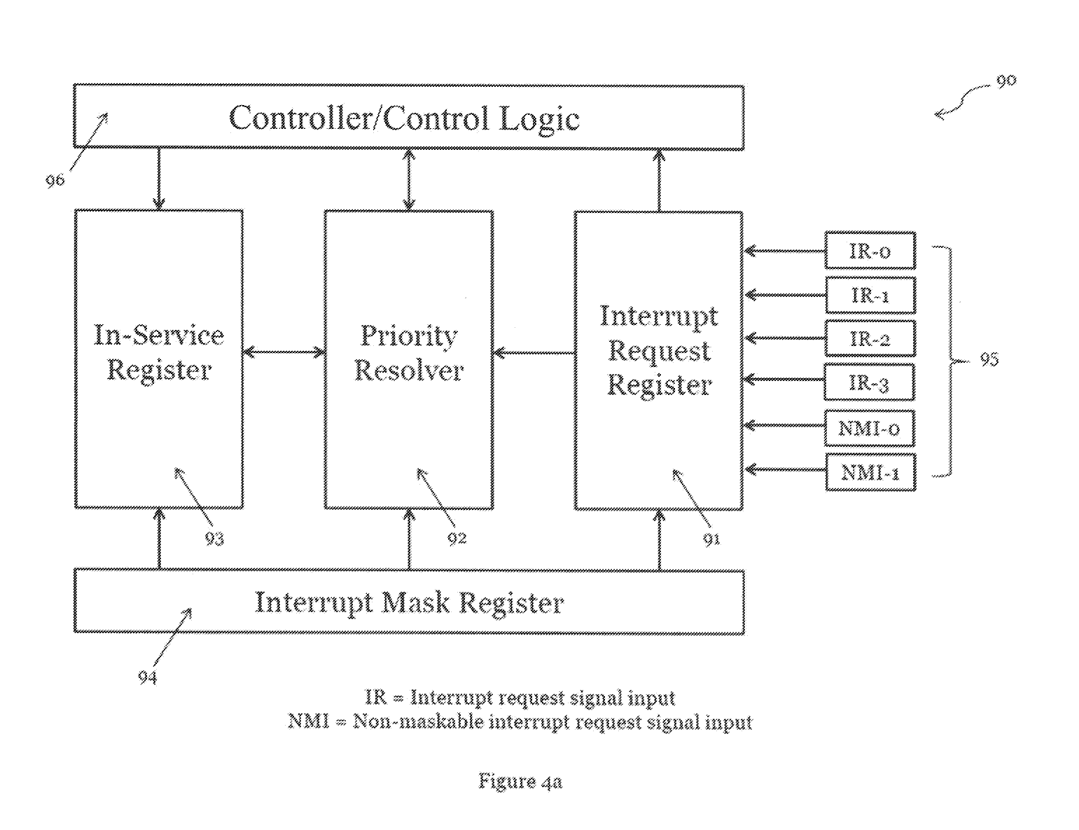

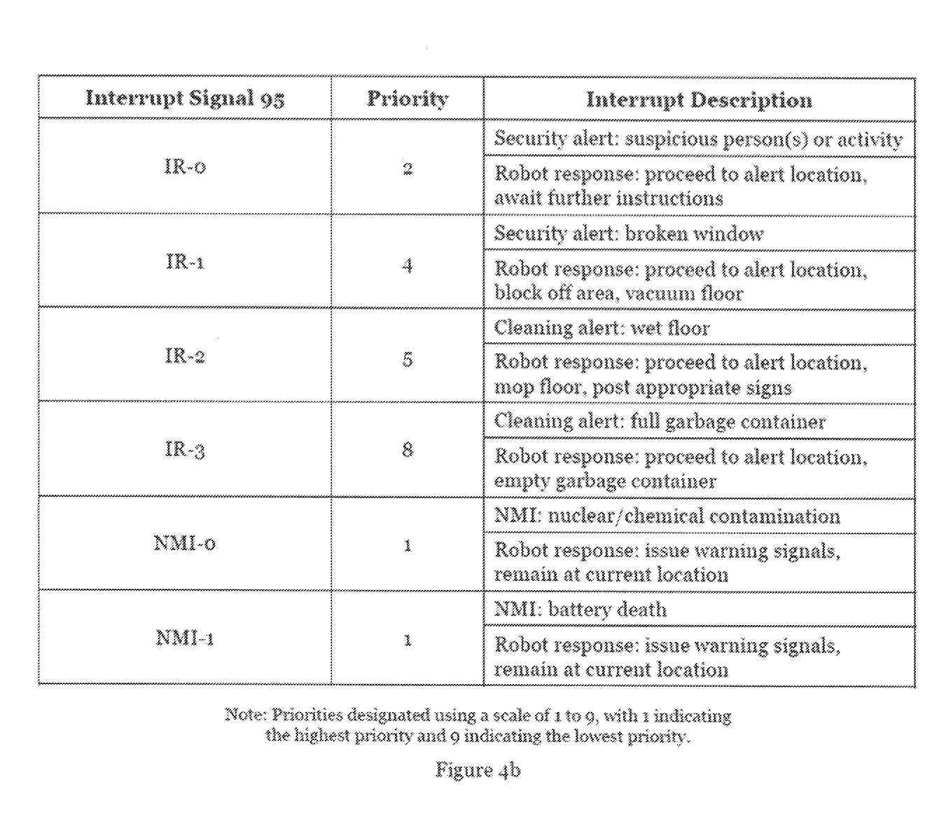

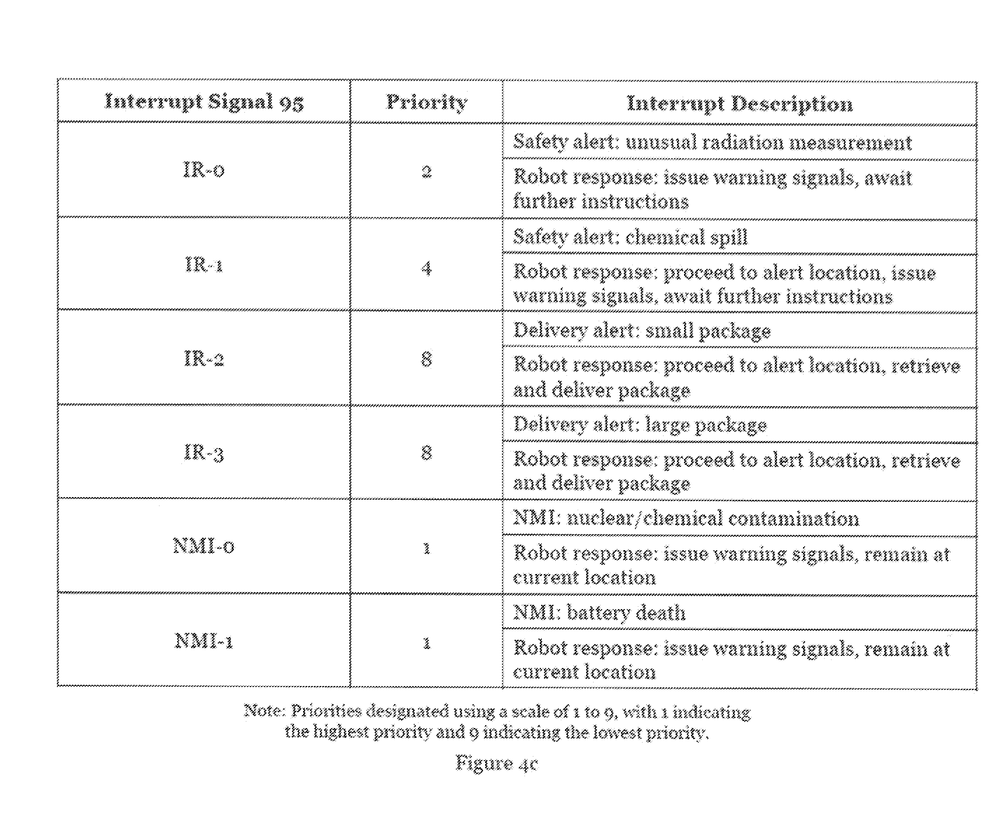

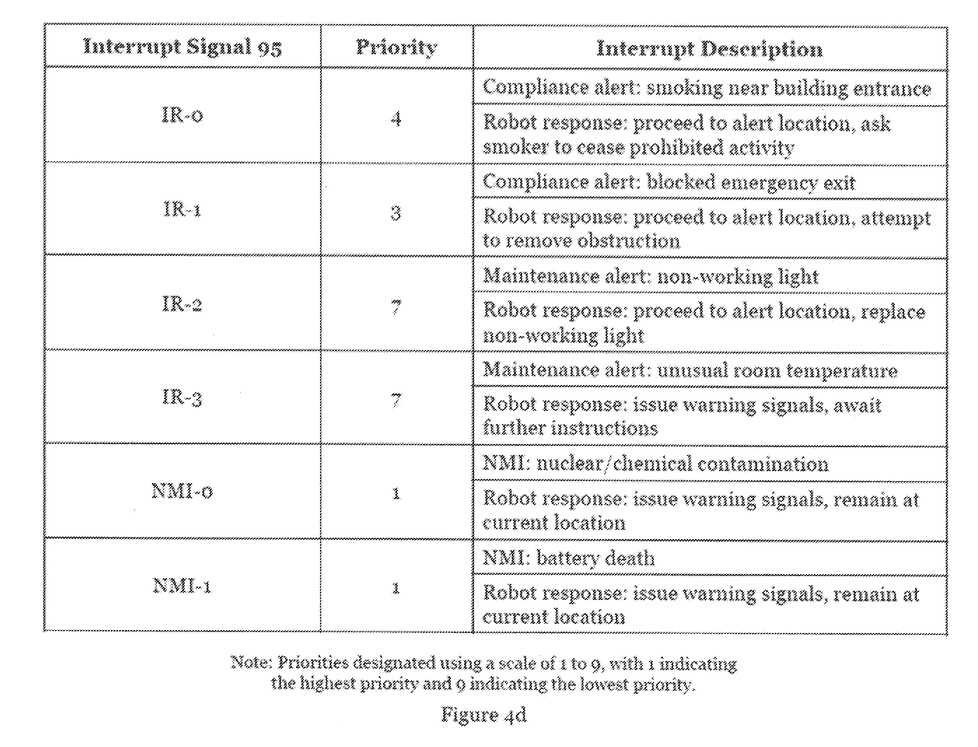

The robot and/or server memory can have one or more databases having a list of tasks, interrupt signals for each task, priority scores for each task (described below and in FIGS. 4b-4d), task histories for each robot, performance (e.g., speed, time to completion, interruption logs, result) for each robot for each task, or combinations there. The robot and/or server memory can have a map of the environment 300. For example, the map can include the location of the perimeter of the environment 300, walls 315, doors, 310, locations of the robots 20, sensors 12, server 14, and combinations thereof. The environment 300 can have one or more zones in the map. For example, hallways/corridors, rooms, cubicles, yards, lanes, platforms, ports, docks, and runways can individually or combination by labeled as different zones in the map data. The zones in a single map can overlap or be non-overlapping.

As the robots 20 move through the environment, sensors on the robots 20 can detect and confirm or update the map data. For example, the robots 20 can have RF tag sensors, visual sensors and/or radar to detect the distance and direction of the surfaces of nearby objects, such as walls, or RF tagged objects such as specific chattel, to the sensors, and the robots 20 can have GPS and dead-reckoning sensors to determine the position of the robot 20. The robots 20 can confirm or update the map data in the robot and/or server memory based on the surrounding surfaces and position of the robot.

The roaming sensor system can include sensors and/or systems one or more robots 20, on a permanent, semi-permanent, or temporary building or environment 300, on other mobile objects including people (e.g., on clothing, in a backpack or suitcase) or animals (e.g., in or on a police K-9 vest), or combinations thereof. Robots, environments/buildings, and other mobile objects can be equipped with sensors, navigation systems, control systems, communication systems, data processing systems, or combinations thereof.

A roaming sensor system can include at least one robot. The robot can be outfitted with sensors and task performing devices. One or more robots can be deployed and managed as a service platform designed to provide services and tasks for an organization and/or a facility or campus, and the software can be managed from a centralized location that may or may not be located at the facility or campus. Such a service could have fixed capital costs or could have a subscription fee for the use of services, tasks, the number of robotic systems deployed simultaneously or serially, the number of patrols, the number of routes, the number of security events detected, or any other suitable measurement of use of the robotic system service platform. The system can assign multiple tasks to one or more robots, to perform multiple simultaneous tasks on one or more robots, to allocate computing resources to process sensor data collected by one or more robots and/or make allocation decisions based upon the results of the data processing, to prioritize the performance of tasks by one or more robots, to enable one or more robots to cooperate with one or more robots, humans, or other elements in the environment to complete a task, and/or to cooperate with at least one other robot to perform a task that can be performed more effectively and/or faster by at least 2 robots, such as a cleaning task or a security patrol.

Roaming sensor system tasks can include security tasks, safety tasks, self-maintenance tasks, building/environment maintenance tasks, compliance tasks, cleaning tasks, gofer tasks, or combinations thereof. Security tasks can include patrolling an area, responding to alarm signals, and detecting suspicious people and/or activities. The alarm signals can be sacrificial alerts, for example, a robot patrolling an area that detects radiation or comes into contact with dangerous chemicals or biological agents can ‘sacrifice’ itself, and cease all activity and/or movement except sending an alert, which can prevent contamination. In this way, the robotic system can be Hippocratic and “first do no harm.” A robot sacrifice could be that the robot self-destructs either partially or fully, to prevent a malicious or careless operator from accidentally spreading contamination. Safety tasks can include monitoring radiation levels, detecting and responding to chemical spills, fires, and leaks, and determining the extent and/or source(s) of chemical spills, fires, and leaks. Self-maintenance tasks can include charging robot batteries, repairing motors and/or other parts, uploading data and/or syncing with other robots, and downloading data (which can include maps, instructions, and updates). Building/environment maintenance tasks can include checking for burnt out lights, performing lifecycle analysis (e.g. for fluorescent lights and mattresses), monitoring soil moisture levels, checking for cracks in sidewalks and roads, checking for discoloration in ceiling tiles, monitoring building temperatures (e.g. HVAC effect mapping), checking for structural damage and/or other abnormalities (e.g. slippery floors and unusual machine sounds), monitoring silt levels along a barge route, and turning off lights (e.g. at the end of the business day and in unused rooms). Compliance tasks can include monitoring hallways and exits (e.g. detecting boxes that are stacked too high and checking that fire exits are accessible), detecting unsafe activities (e.g. smoking near building entrances), and monitoring parking structures (e.g. checking for illegal parking in handicap spaces). Cleaning tasks can include monitoring building/environment cleanliness; waxing, sweeping, vacuuming, and/or mopping floors; emptying garbage bins; and sorting garbage and/or recyclables. (Gofer tasks can include retrieving and/or delivering mail and other packages, fetching refreshments, making copies, answering doors, and shopping (e.g. retrieving paper from a storage closet, notifying an operator that there are no more staples, and/or going to a supply store).

The roaming sensor system can communicate, for example by sharing acquired data with humans and/or other robots, triggering responses, and providing instructions. The roaming sensor system can transmit numerical data to a storage server via a wireless network (e.g., Wi-Fi, Bluetooth, 4G, 3G, LTE, GPRS modem, hard line wire docking station).

The roaming sensor system can communicate through a social interface between one or more robots and one or more humans. A social interface would allow a robot to interact with humans using voices and/or images, pictograms, facial expressions, gestures, touch, and other communication methods that humans use. A robot equipped with a social interface can use customizable social interfaces, such as one or more novelty voices, which can include licensable theme voices and corporate officer voices. Licensable theme voices can include Star Wars, Borat, Star Trek, The Simpsons, Family Guy, and combinations thereof. Corporate officer voices can include Steve Jobs, Larry Ellison, Bill Gates, Steve Ballmer, and combinations thereof. A robot can counsel and provide people management by asking questions, detecting stress in human voices, and responding appropriately to influence emotions. For example, a robot detecting sadness can sympathize, tell jokes, offer to bring coffee or a newspaper, or simply leave the person alone (e.g. if the person was annoyed by the robot). A robot can perform customer service tasks. For example, a robot can answer customer questions about store hours, product location, and product availability.

### Resource Management System

Resource management hardware and/or software executing on the processors in the server or robots can allocate resources and manage tasks for the roaming sensor system. Resource allocation can include dividing workloads (e.g. across multiple robots and/or humans); optimizing resource consumption, time spent on particular tasks, battery usage (e.g. amount of battery life spent on collecting and/or transmitting data), and robot patrol coverage (e.g. dividing paths among multiple robots); improving task completion times; and coordinating responses to events such as security threats, safety threats, maintenance events (e.g. a light bulb burning out), or combinations thereof.

The resource management hardware and/or software can direct the processor to instruct the first robot with a first task, and the second robot with the first or second task. Urgent instructions for the robots to perform tasks are interrupt request (IR) signal inputs. The resource management hardware can receive or create interrupt request (IR) signal inputs.

Sensors on the robot and/or elsewhere in the environment can detect signals and send data relating to the detected signals to the processors on the robots and/or servers. The processors can then instruct the robots to perform a task based on the data relating to the detected signals.

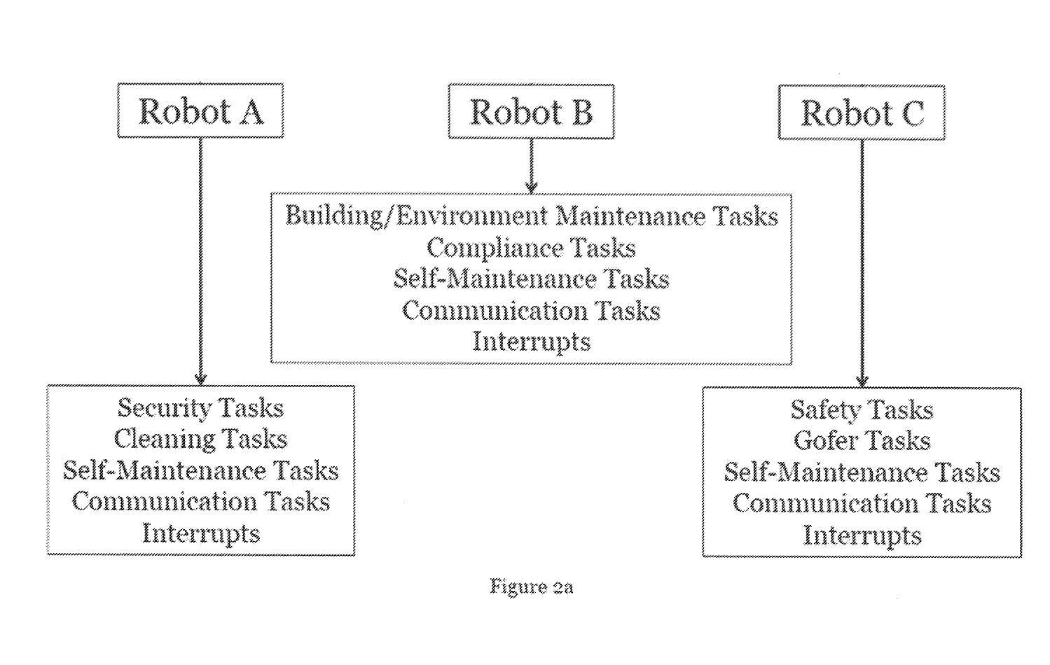

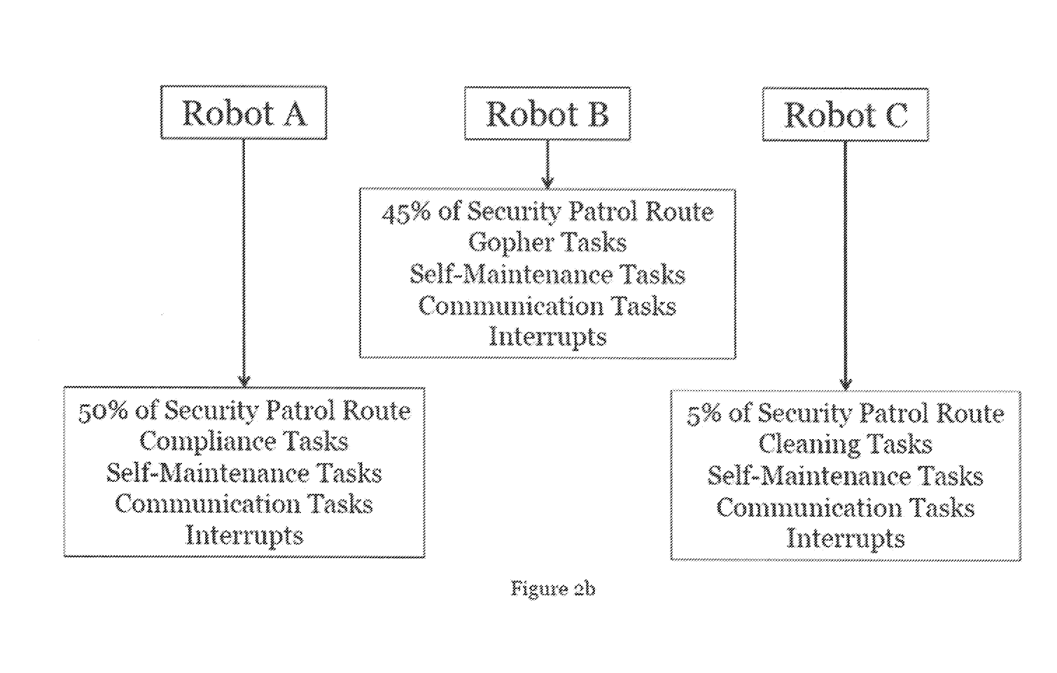

As shown in FIG. 2a, robots can be designed with compartmentalized functionalities. For example, one robot can be a security/cleaning robot, a second robot can be a maintenance/compliance robot, and a third robot can be a safety/gopher robot. Workloads, which can include security tasks, safety tasks, self-maintenance tasks, building/environment maintenance tasks, compliance tasks, cleaning tasks, and/or gofer tasks, can be shared, allocated, balanced, and/or divided among two or more robotic systems according to functionality. For example, a workload including security tasks and compliance tasks can be shared such that a security/cleaning robot performs security tasks and a maintenance/compliance robot performs compliance tasks. Alternatively, a workload including security tasks and compliance tasks can be shared such that a security/cleaning robot and a security/maintenance robot perform security tasks and a gofer/safety/compliance robot performs compliance tasks. In some embodiments, the system may be configured to reassign or reallocate functionalities between the robots of the system. For example, as shown in FIG. 2a, if Robot A were to breakdown or otherwise become unavailable, the system would reassign at least a portion of the tasks assigned to Robot A to Robots B and C. In some embodiments, only higher priority tasks might be reassigned, while lower priority tasks might remain uncompleted until Robot A returns to service. Such adjustments or modifications can be optimized for specific organizational priorities, which can also vary. This reassignment of tasks, as needed, could be managed manually, automatically, or self-directed between robots.

For example, a controller on one or more processors can distribute (i.e., instruct to perform) a first task to a first robot and a second task to a second robot. When the controller detects that the first robot has completed the first task or is otherwise has capacity to perform another task (e.g., while waiting for a step in the first task that the robot does not actively perform, such as waiting for a slow chemical reaction to occur before detecting the results), the controller can instruct the first robot to perform the second task. For example, the controller can instruct the first robot to perform the entire, only the remaining portion, or a part of the remaining portion of the second task and let the second robot continue to perform the remainder of the second task. The first robot can communicate with the controller (e.g., on the server) that the first robot has completed the tasks, or is waiting for the tasks assigned to the first robot when the first robot is at that respective stage.

The controller can divide a single task into multiple parts and initially instruct different robots to perform different parts of the first task (e.g., the first robot can be assigned the first portion of the first task and the second robot can be assigned the second portion of the first task). The controller can then rebalance the remaining processes required by the first task between the first and second robots when the first and/or second robots are partially complete with the first task. The controller can assign a second task to the first robot to finish the assigned portion of the task.

A robot can be outfitted (either manually, automatically, or self-directed) with service modules. Manual outfitting can be performed by an operator or a service technician or another robot. Self directed outfitting can be performed by the robot itself, and similarly, automatic outfitting can be performed as a robot interacts with another system, such as a battery changer, or an automatic module changing device. Service modules can include tools or features adapted for specific tasks. For example, a robot can attach a basket on top of itself when preparing to perform gopher tasks and/or deliver mail. As another example, a robot could attach a spotlight to itself for an outdoor security patrol at night.

As shown in FIG. 2b, Robot A can be tasked by processors in the system with 50% of a security patrol route or task, Robot B can be tasked with 45% of a security patrol route or task. Robot C can be tasked primarily with a cleaning duty and can finish up an allocation of 5% of a security patrol route or task (e.g. on the way to and from a cleaning site) to assist the other robots and possibly to speed up the completion of the security task. The tasking can be read by the processors from a database listing the robots and the tasks for each robot. Tasks requiring uncertain amounts of time can be re-divided and allocated across and/or assigned among multiple robots. Coordinating responses can involve collaborating with one or more robots, maintenance staff, security staff, and/or administrative/support staff.

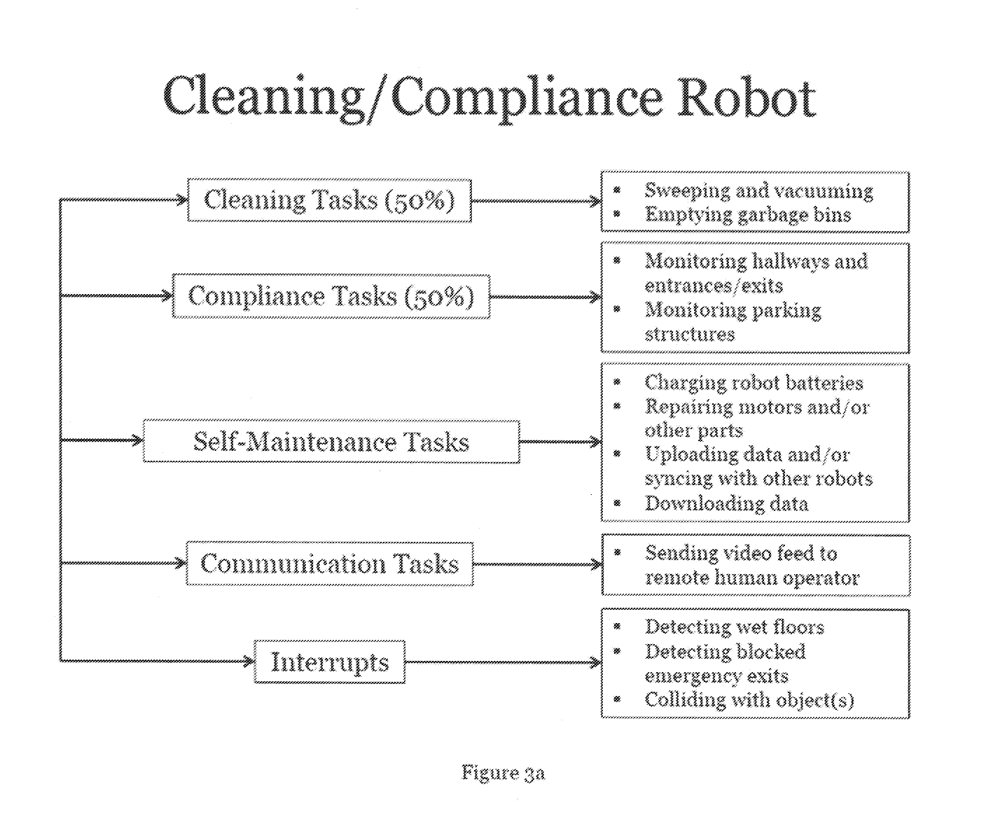

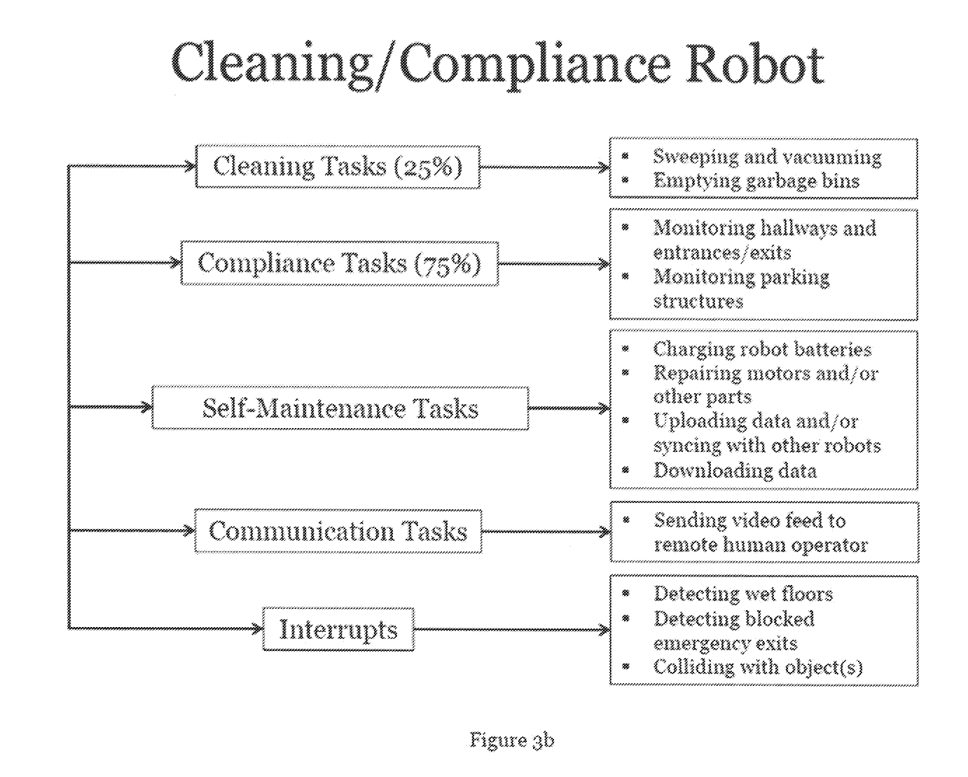

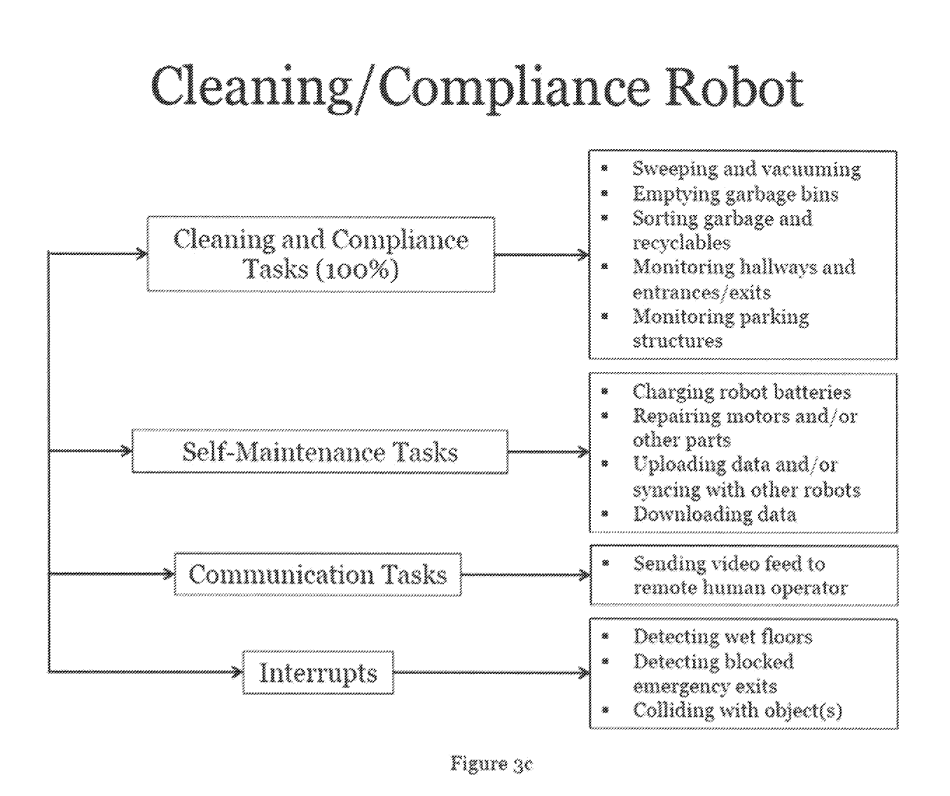

A robot having two or more functionalities can share and/or divide its time among particular tasks. A robot can perform multiple tasks simultaneously and/or allocate a certain percentage of its time on each task. As an example, a robot running 3 tasks can pause the first task and perform a second task while running a third task simultaneously. Simultaneously in this context can include running a task completely or partially in parallel, or simultaneously can also mean sharing time on a processor and context switching between two tasks until one or both of the tasks complete, similar to how a modern operating system fakes multitasking for users of a GUI on a Windows, Mac or Linux operating system. As shown in FIG. 3a, a cleaning/compliance robot can divide its available capacity for tasks and/or operating time evenly among cleaning tasks and compliance tasks. As shown in FIG. 3b, a cleaning/compliance robot can spend more time performing compliance tasks than cleaning tasks. As shown in FIG. 3c, a cleaning compliance robot can perform cleaning tasks and compliance tasks at the same time.

Task management can involve tasks that can be actively started by an operator or a server allocation system, tasks that can be latent and/or run constantly in the background, and/or tasks that can be scheduled to run regularly. For example, alarm signal response can be actively started, radiation level monitoring can run constantly, and robot battery charging can be scheduled. For example, a security patrol robot can monitor carpet cleanliness (e.g. in a hotel or office building), wear patterns, unsafe conditions, and chemical leaks (e.g. in an industrial environment) while also monitoring for security threats. Over time, a dataset could be used to predict or schedule maintenance, cleaning, and/or safety checks; all of this information could be gathered by at least one robot as a background data collection process during regular security patrols. Additionally, as unscheduled resources become available (e.g. a robot finishes a charge cycle or is dismissed from a task by a human operator), tasks can be re-allocated across all robots. Alternatively, these additional robots can be used to complete higher priority tasks faster, and then lower priority tasks can be re-allocated across all robots.

As shown in FIG. 4a, a roaming sensor system can be interrupt driven such that task management can involve a priority engine 90. The priority engine 90 can be hardware including one or more processors in the system or can be digital logic distributed across multiple processors in the system and/or software executing processors containing custom digital logic and/or software distributed across one or more processors. The priority engine 90 can include one or more interrupt request (IR) signal inputs 95, an interrupt mask register 94, an interrupt request register 91, a priority resolver 92, an in-service register 93, and a controller 96. The controller 96 can instruct the robot to directly perform tasks. The interrupt mask register 94 can store a queue of tasks awaiting execution by the system or specific robot 20.

Interrupt request signal inputs 95 can be logged in an interrupt request register 91, which can pass each IR to a priority resolver 92. A priority resolver 92 can rank each IR according to its pre-assigned priority score and pass the IRs to a controller 96 in order, e.g. starting with the highest-priority interrupt request (i.e., the IR with the highest score). Alternatively, a priority resolver 92 can assign priorities randomly or handle IRs in a first-in-last-out, last-in-first-out, or round robin prioritization scheme. An in-service register 93 can keep track of which IRs are currently being handled by the controller 96. An interrupt mask register 94 can keep track of which IRs are currently being masked, i.e. ignored, by a controller 96. For example, a priority resolver 92 handling three IRs, e.g. R-1, R-2, and R-3, can rank the IRs according to their pre-assigned priorities and pass the highest priority IR, e.g. R-2, to a controller 96. An in-service register 93 can keep track of the fact that the controller 96 is currently managing R-2, while an interrupt mask register 94 can keep track of the fact that the controller 96 is currently ignoring R-1 and R-3. Once the controller 96 has finished processing/servicing/handling R-2, the in-service register 93 can keep track of the fact that the controller is now managing R-1 and R-3, while an interrupt mask register 94 can keep track of the fact that the controller is now no longer ignoring any IRs.

For example, the robot 20 can be controlled to perform a first, instructed task. An IR can then be received by the interrupt request register 91. The interrupt request register 91 can send the IR to the priority resolver 92. The in-service register 93 can inform the priority resolver 92 that the controller 96 currently has the robot performing the first task.

The priority resolver 92 can then compare a priority score of the first task to a priority score of the second task (as found in the task list in a database in memory). If the priority score of the first task is higher than the priority score of the second task, the priority resolver 92 can send the second task request to the interrupt mask register 94 to wait until the second task has a higher priority score than any other tasks in the interrupt mask register and the task in the in-service register before the second task can be performed by the robot. If the priority score of the first task is lower than the priority score of the second task, the priority resolver 92 can stop the controller 96 from having the robot execute the first task, send the first task to the interrupt mask register 94 (along with the current execution progress of the first task) to wait until the first task has a higher priority score than the highest priority score of tasks waiting in the interrupt mask register 94 and the task in the in-service register 93 to be completed, and send the second task to the in-service register 93 and instruct the controller 96 to execute and have the robot perform the second task. The priority engine 90 can be partially or entirely executed by processing hardware and/or software executing on a processor on the respective robot, on a different robot, on the server, or any combinations thereof.

IRs can include sensor inputs and operator commands. For example, an IR may include the detection, by a robot, of one or more suspicious people or activities. IRs can be non-maskable interrupts (NMIs), i.e. the interrupt cannot be ignored. For example, an NMI may include the detection, by a robot, of radiation exposure, and that it has been exposed to an amount of radiation that can render it unsafe to leave the area and/or return to its return location (e.g. a charging station or “home base”). In such an instance, the radiation exposure interrupt service routine could require a robot to ignore all other interrupt requests while a radioactive contamination IR was being processed/serviced/handled, and any maskable interrupt requests would therefore be masked. As shown in FIGS. 4b, 4C, and 4d, IRs can be optimized for robots having various functionalities, including security/cleaning robots, safety/gofer robots, compliance/maintenance robots, and/or any other suitable combination of robot functionalities.

As shown in FIG. 4b, IRs for a security/cleaning robot can include detecting suspicious person(s) or activity, detecting a broken window, detecting a wet floor, and detecting a full garbage container. NMIs for a security/cleaning robot can include detecting nuclear and/or chemical contamination and battery death. Suspicious person(s) or activity, for example, can be assigned a higher-ranked interrupt than a full garbage container. If a security/cleaning robot were to detect both, the priority resolver could instruct the controller to ignore the full garbage container and respond to the suspicious person(s) or activity. If a security/cleaning robot were to detect nuclear/chemical contamination and/or battery death, the priority resolver could instruct the controller to ignore, i.e. mask, all other interrupts and/or to stay in place to avoid spreading nuclear/chemical contamination while waiting for a human or another robot to provide additional support.

As shown in FIG. 4c, IRs for a safety/gofer robot can include detecting an unusual radiation measurement, detecting a chemical spill, receiving an order to deliver a small package, and receiving an order to deliver a large package. NMIs for a safety/gofer robot can include detecting nuclear and/or chemical contamination and battery death. A chemical spill, for example, can be a higher-ranked interrupt than an order to deliver a package. If a safety/gofer robot were to detect both, the priority resolver could instruct the controller to ignore the package delivery order and respond to the chemical spill. If a safety/gofer robot were to detect nuclear/chemical contamination and/or battery death, the priority resolver could instruct the controller to ignore all other interrupts.

In some embodiments, a gopher robot could also follow a user, possibly playing background music that the user likes, and waiting for instructions from the user. In a household, such user tasks can include fetching a newspaper; checking on a timer, temperature, water on the stove, bath water; and performing security checks and patrols while a user is away from the residence, asleep, and/or working in another part of the house, e.g. the robot can be connected over an internet connection so that the user can control the robot as an avatar while at a different location.

As shown in FIG. 4d, IRs for a compliance/maintenance robot can include detecting a person smoking near building entrance, detecting a blocked emergency exit, detecting a non-working light, and detecting an unusual room temperature. NMIs for a compliance/maintenance robot can include detecting nuclear and/or chemical contamination and battery death. A blocked emergency exit, for example, can be a higher-ranked interrupt than a non-working light. If a compliance/maintenance robot were to detect both, the priority resolver could instruct the controller to ignore the non-working light and respond to the blocked emergency exit. If a compliance/maintenance robot were to detect nuclear/chemical contamination and/or battery death, the priority resolver could instruct the controller to ignore all other interrupts.

Interrupt priorities can be adapted, modified, or adjusted as additional robots and/or resources become available. Such adjustments or modifications can be optimized for specific organizational priorities, which can also vary. For example, robots can function as gopher/safety robots during normal working hours, cleaning robots during evening hours, and high-alert security robots after midnight. When a robot finishes a cleaning task, the priorities of its interrupts could be adjusted to focus primarily on security.

### Route Allocation

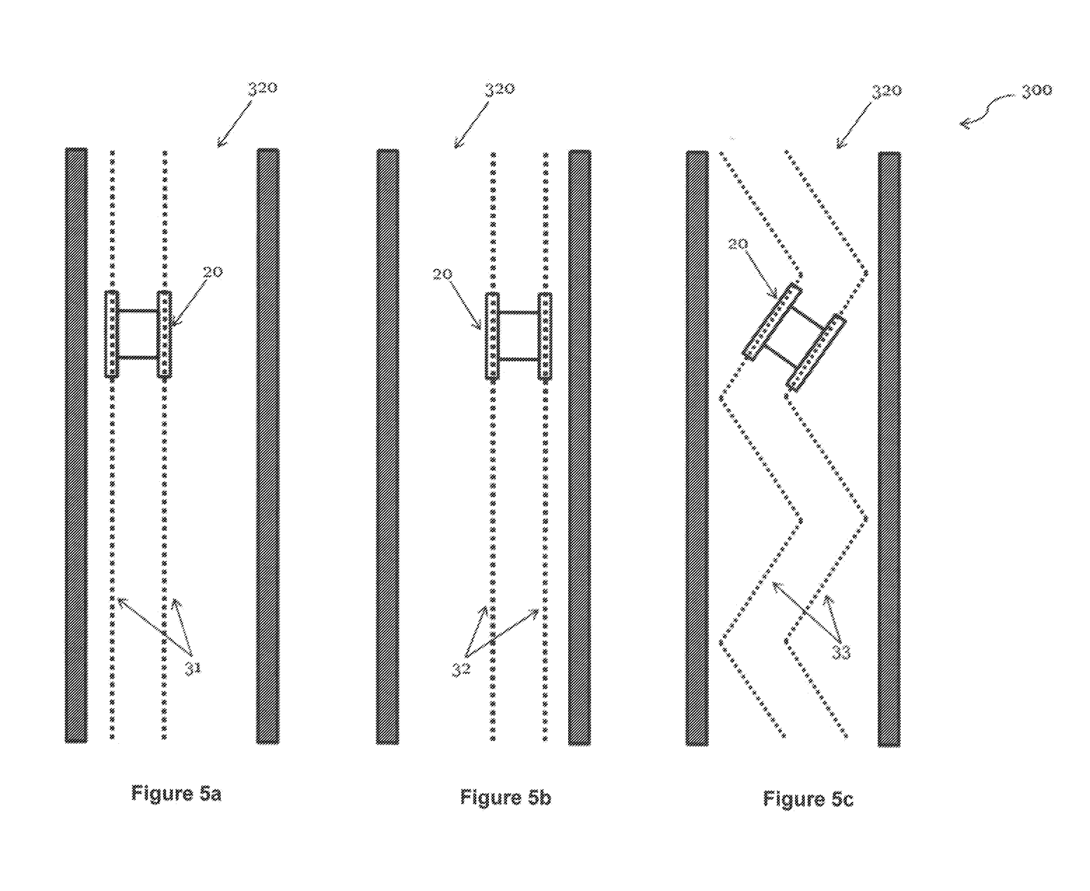

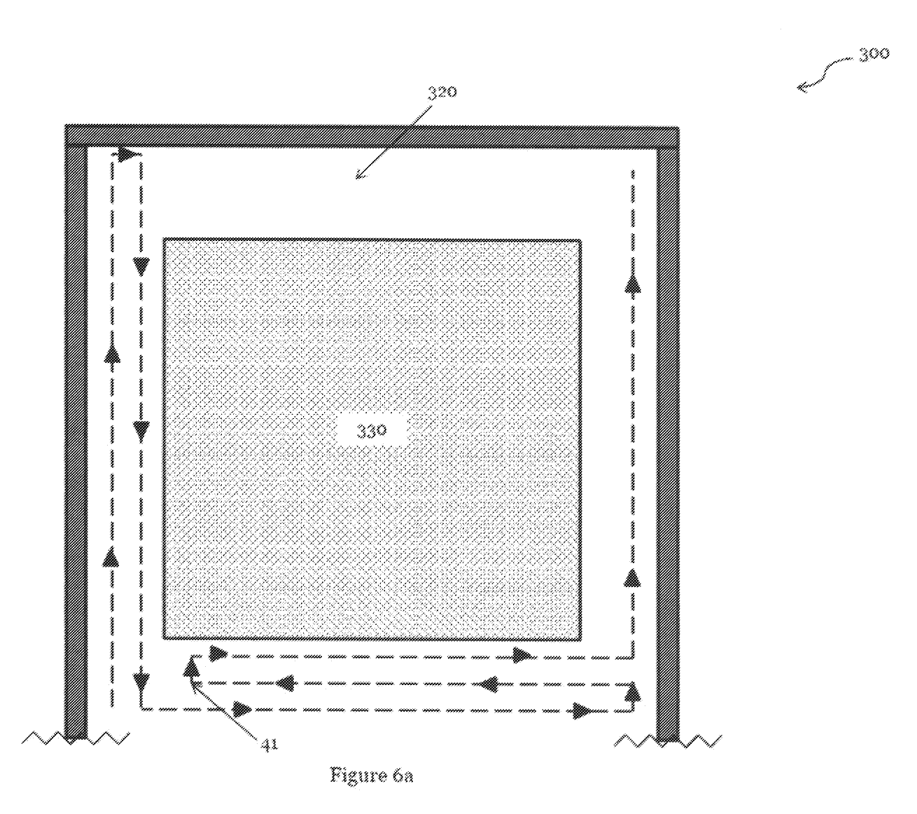

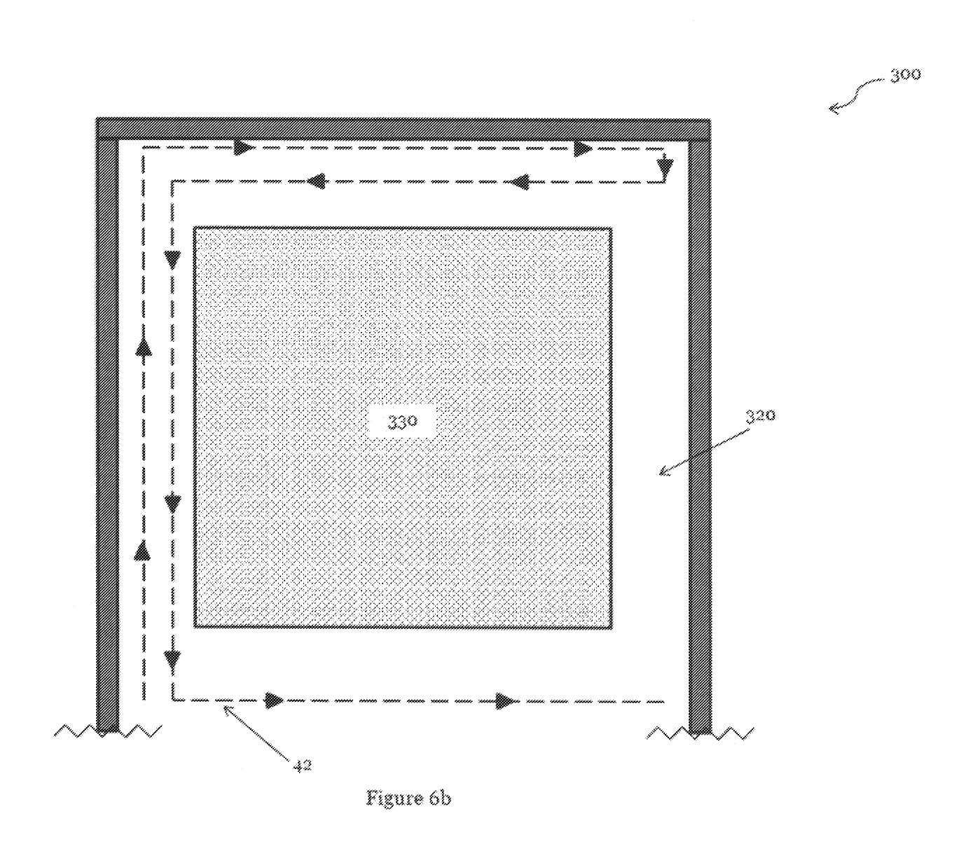

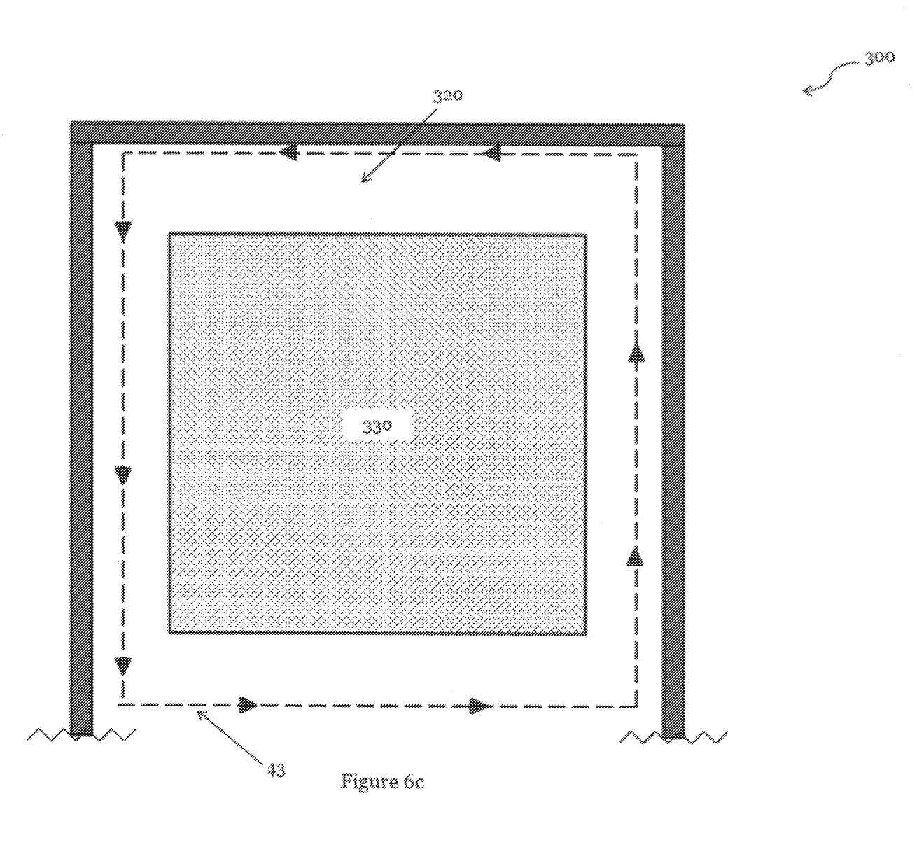

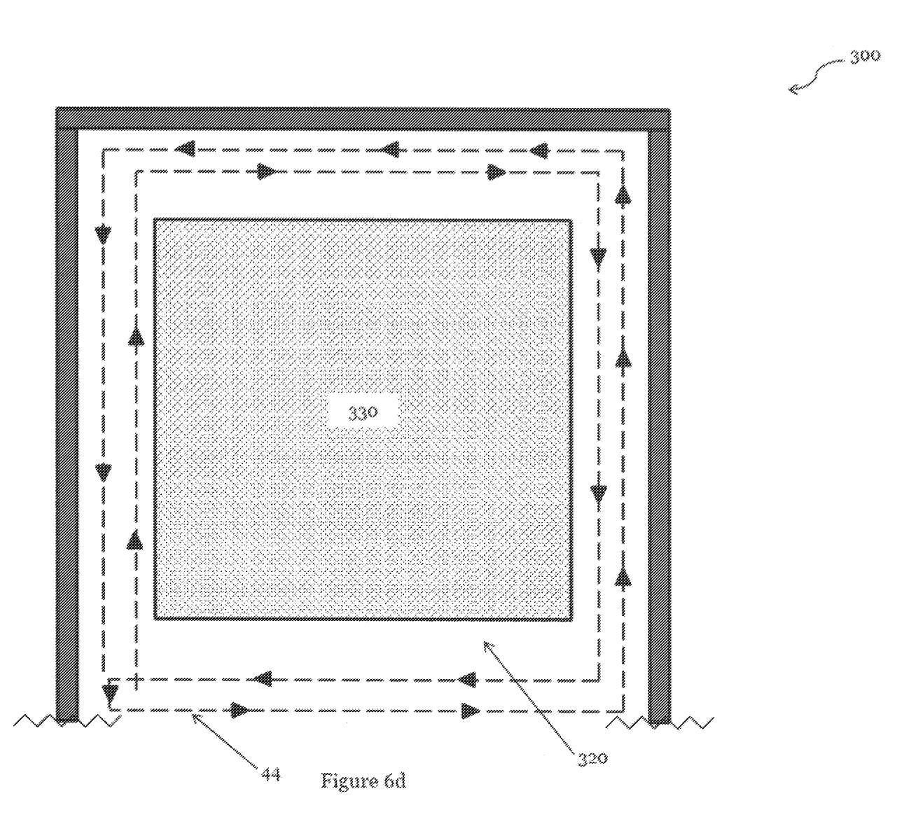

As shown in FIGS. 5a-5c, 6a-d, 7, 8, and 9, robot routes within a building/environment can be selected for particular tasks and areas. Robot paths can be allocated entirely to a single robot or can be allocated across multiple robots. Routes can include wear-leveling routes, randomized routes, flanking routes, routes targeting high-alert areas, and routes specialized for high-risk situations.

The robots 20 can have sensors, such as described herein including cameras. The sensors on the robots 20 and/or positioned elsewhere in the environment 300 can, for example, be cameras capturing images of the ground of the environment (e.g., carpet, hard flooring such as tile, marble or hardwood, grass) under and near the robots. The signals from the cameras can be processed by one or more of the processors in the system (e.g., determining height of carpet fibers, reflection of light from carpet or tile, or combinations thereof) to identify a wear level for each location of the ground of the environment.

Wear-leveling routes can be used to prevent excess wear on floor surfaces, such as marble floors, carpeted floors, grass, or combinations thereof. One or more of the processors in the system can instruct a first robot 20 to follow a first path in a first zone on the map of the environment during a first traversal of the zone by the first robot 20 at a first time. One or more of the processors can instruct the first robot 20 to follow a second path in the first zone during a second traversal of the zone by the first robot 20 at a second time later than the first time. The first path and the second path can, for example, cross but not have collinear portions where the ground has more wear than the average wear along all of the robot paths instructed by the system in the zone. One or more of the processors can instruct a second robot to follow a third path in the first zone concurrent with the first robot or at a third time. For example, the third path can cross but not have collinear portions with the first or second paths.

The processors can generate the paths based on the wear data determined by the sensors.

One or more of the processors can generate random paths through the zone for the first and/or second robots.

The processors generating the routes or paths for the robots to follow can be on the robots, the server, or combinations thereof. The map data used to generate the routes can be on the memory of the robots, server, or combinations thereof.

Wear-leveling routes can also improve sensor monitoring over a larger area and refresh data more frequently and evenly. As shown in FIG. 5, a robot 20 can follow a wear-leveling route 31, 32, or 33 while traversing a hallway 320 in a building/environment 300. A robot can alternate routes to aid in wear leveling; for example, a robot 20 can follow route 31 in the mornings and route 32 in the evenings. Likewise, multiple robots can alternate routes to aid in wear leveling; for example, a robot 20 can follow route 32 while another robot 20 can follow route 33.

Randomized paths can be used to avoid detection by adversaries. As shown in FIGS. 6a, 6b, 6c, and 6d, a robot in a building/environment 300 can follow a randomized route 41, 42, 43, or 44 while patrolling the areas surrounding a room, closet, or other office space 330. A robot can alternate routes to avoid detection; for example, a robot can follow routes 41, 42, 43, and 44 according to a randomized schedule. Likewise, multiple robots can alternate routes to avoid detection. For example, a robot can follow route 41 while another robot 20 can follow route 43.

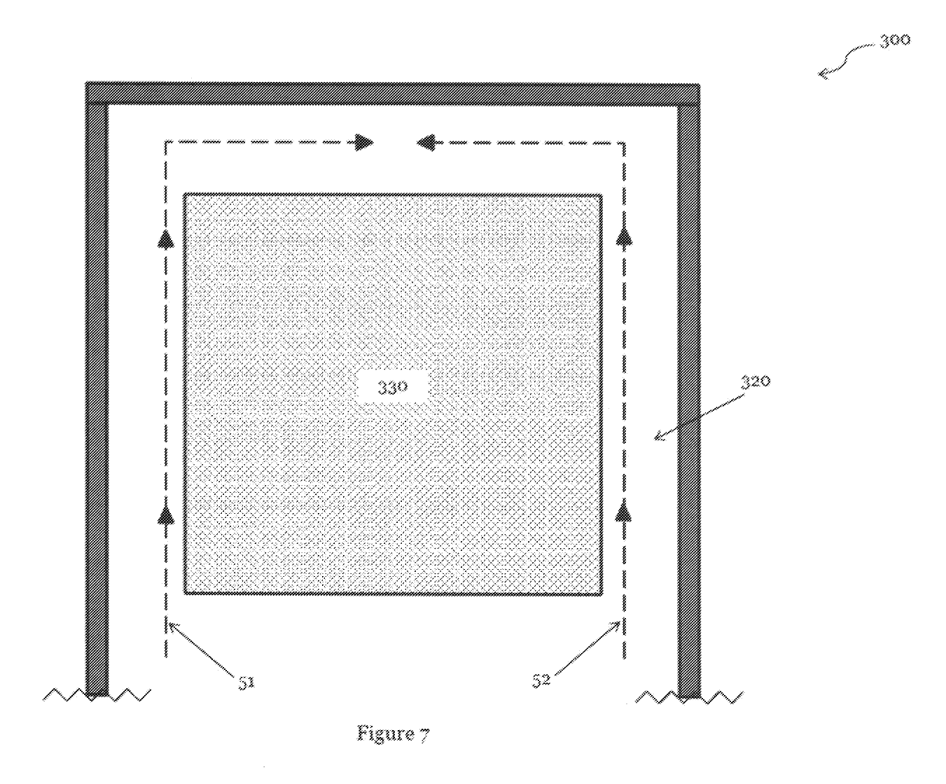

Flanking routes can be used to detect, intimidate, distract, and/or prevent suspects fleeing a scene, determine the source and/or extent of a leak, fire, or spill, and avoid an area that another robot is cleaning. As shown in FIG. 7, a robot can follow route 51 or 52 to reach an incident location near a room 330. Two or more robots can follow flanking routes to gather more information about an incident; for example, a robot 20 can follow route 51 to reach an incident location while another robot can follow route 52 to approach the incident location from the opposite direction.

Depending on the priority of a response, flanking routes can be combined with wear-leveling routes to improve and/or optimize wear leveling on a floor surface. Taking a wear-leveling route could slightly increase a robot's response time, but in some situations an extra second or two might not make a significant difference; for example, a small water leak (such as a drip) could be detected and monitored by a pair of robots using both flanking and wear leveling routes. In a situation where response time is more important, taking a wear-leveling route can be omitted or delayed/queued; for example, a human intruder could be flanked by a pair of robots using only flanking routes.

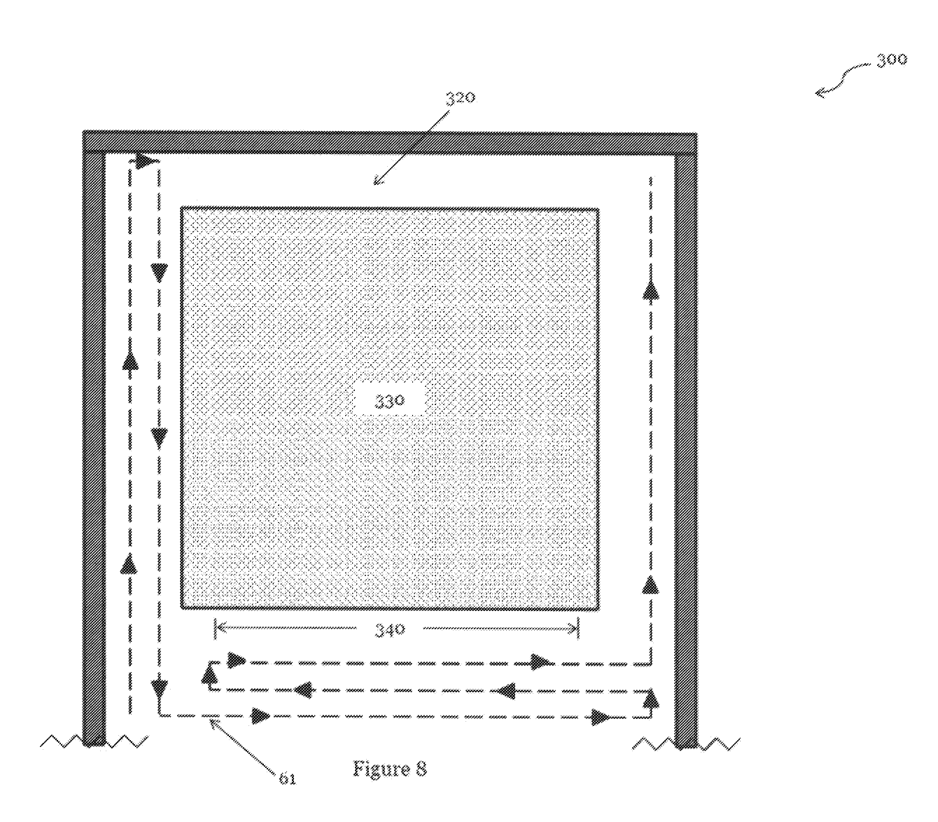

Routes can be targeted such that a robot spends more time patrolling a high-alert area, e.g. a main entrance or bank vault. As shown in FIG. 8, a robot in a building/environment 300 can follow route 61 to target a high-alert area 340.

Routes can be specialized for high-risk situations, e.g. moving valuable assets. For example, in the week prior to emptying a bank vault, robots can follow randomized routes while patrolling the area so that adversaries will be unable to find patterns in security coverage. On the day the vault is emptied, robots can follow targeted routes to increase security coverage.

Routes can also be modified in response to significant events, e.g. a robbery or chemical spill. For example, in the weeks following a chemical spill in a laboratory, robots patrolling the area can follow routes targeting the laboratory to ensure that the spill was properly cleaned and the area fully decontaminated. Following a perimeter violation, a robot can be assigned a path that marks a particular portion of the perimeter as a higher risk area such that the robot patrols that area more often and/or more slowly. The security patrol coverage area can be defined as the area covered by a security patrol. Some areas can have a higher security patrol requirement (e.g. the gold vault has a higher priority than the lunch room and gets more visits and thus more “security coverage” than the lunchroom). The routes can be modified based on relative values of assets, risk assessments of entrances, exits, assessments of chemical and physical maintenance requirements, safety monitoring requirements of chemical and physical machinery, previous security events, maintenance events, machinery breakdowns, or other information.

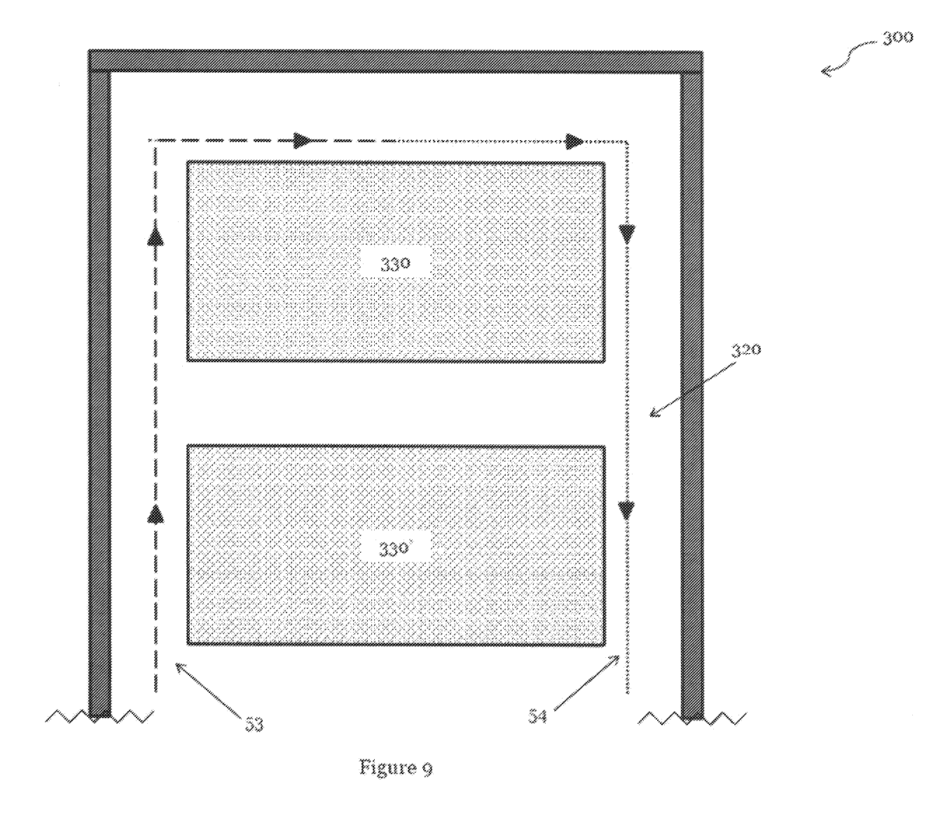

Routes can be allocated to a single robot, or routes can be allocated across multiple robots, as shown in FIG. 9. A route can be allocated across multiple robots to improve the speed of completion of a route, to improve coverage of a mute, to use a robot with more battery power to back up or provide redundancy to a robot with lower battery power, e.g. robot sentry relief duties, or any other purpose. As shown in FIG. 9, a robot can follow routes 53 and 54 to perform a security patrol task near rooms 330 and 330′ in a building/environment 300. Alternatively, one robot can follow route 53 to perform part of a security patrol task while another robot can follow route 54 to perform another part of the security patrol task.

### Building Interfaces

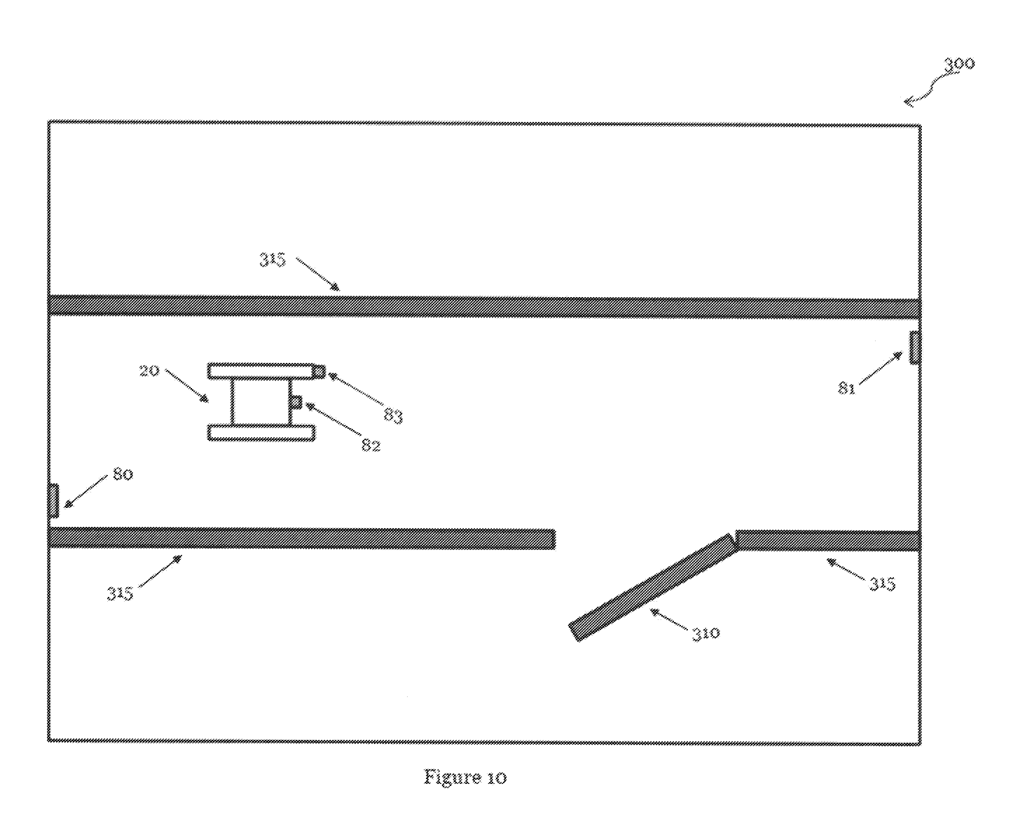

As shown in FIG. 10, robots, buildings/environments 300, humans, or combinations thereof, in a roaming sensor system can be equipped with one or more sensors 12. The sensors 12 can have cameras 80 and 82, thermal imagers 81, lasers, microphones, fire/smoke detectors, carbon monoxide detectors, chemical detectors, radiation detectors (e.g., Geiger counters), thermometers, humidity meters, and combinations thereof. Sensors 12 can aid in navigation, control, communication, and data acquisition and processing. For example, a robot 20 can be equipped with a device that measures and records radiation levels 83, and a human analyst can check for abnormal readings.

A building/environment 300 in a roaming sensor system can be equipped with robot navigation beacons, which can be attached to existing doors 310, walls 315, light posts, and/or in any other suitable location or object, and a robot can be equipped with appropriate sensors. Additionally, a robot can pre-cache one or more downloadable maps of a building/environment. A robot can use a combination of data from its sensors, navigation beacons, and/or maps of a building/environment to determine its position using appropriate methods; for example, a robot can use simultaneous localization and mapping to generate a real-time map of its environment as it performs tasks. Alternatively, a robot can be manually controlled by a human operator.

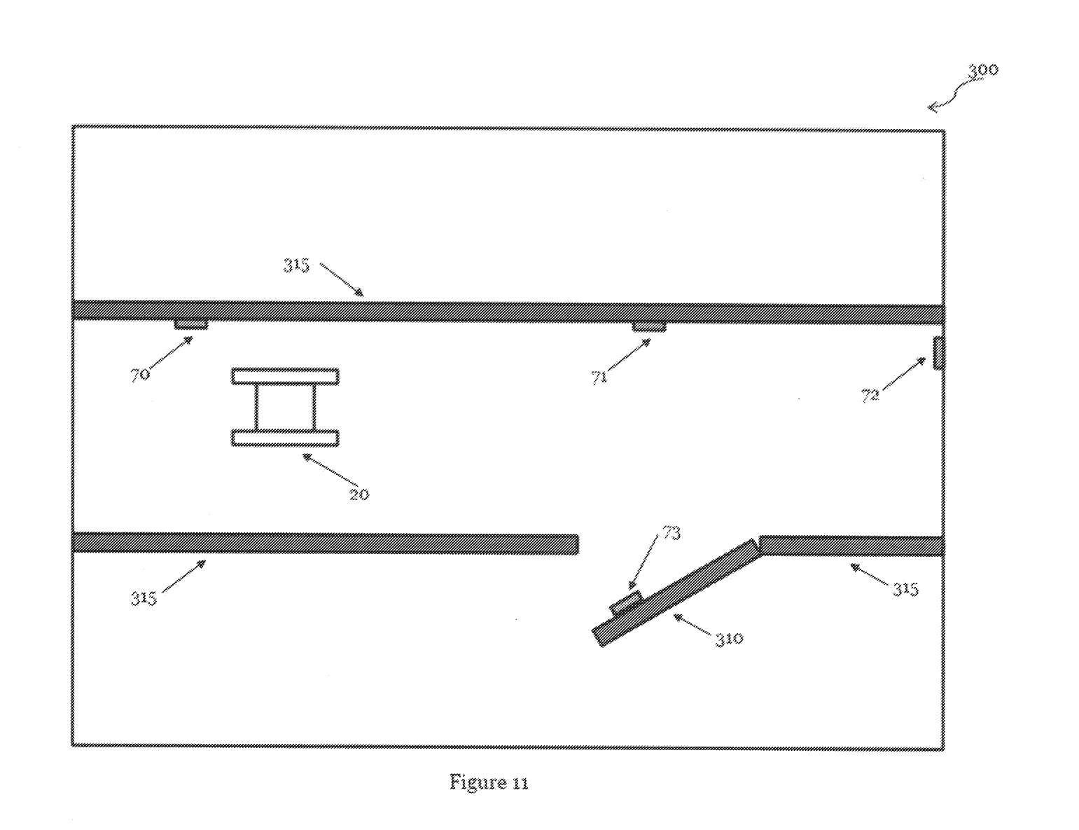

As shown in FIG. 11, a building/environment 300 can be equipped with robot navigation beacons that can provide a robot 20 with information for determining its current location. Robot navigation beacons can include radio frequency emitters at known locations and a robot 20 can use trilateration, triangulation, and/or other suitable methods to calculate its position; for example, a navigation beacon can be a cellular base station 70, a radio broadcasting station 71, a GPS satellite, and/or any other suitable emitter.

As shown in FIG. 11, robot navigation beacons can include sonic emitters and a robot 20 can use sonar to calculate its position; for example, a navigation beacon can be an infrasonic emitter 72, an ultrasonic emitter, and/or any other suitable sonic emitter.

As shown in FIG. 11, robot navigation beacons can include wireless access points and a robot 20 can measure the received signal strength to calculate its position; for example, a navigation beacon can be a wireless router 73, a Bluetooth device, a cellular communications tower, a computer with a wireless Bluetooth or Wi-Fi connection, a wireless repeater, a 3G/4G/LTE radio modem, any type of wireless sensor, laser signals, fiber optics, and/or any other suitable device that provides a wireless connection to a wired network.

A roaming sensor system can visualize and/or analyze collected and/or aggregated data, either in real time for decision making or later, after more data has been collected. Data visualization can aid in detecting anomalies; for example, data visualization can reveal that a measured room temperature of 85° F. is well above the average room temperature of 70° F. and should be reported to a human operator. Data visualization can aid in identifying and addressing security needs, safety needs, building/environment maintenance needs, compliance needs, and cleaning needs. For example, visualization of security alert locations can help a remote analyst identify high alert areas and can correspondingly increase robot patrols of these areas. Visualization of radiation measurements can help a remote analyst identify the source of a radiation leak. Visualization building temperature, humidity, and carbon dioxide levels can help a remote analyst identify areas with inadequate or abnormal ventilation. Visualization of reports of smoking near building entrances can help a remote analyst identify entrances that could benefit from additional signage. Visualization of floor cleanliness after vacuuming can help a remote analyst identify vacuum cleaners that need to be replaced.

Modifications and combinations of disclosed elements and methods can be made without departing from the scope of this disclosure.

We claim:

1. A robot system comprising:
a memory configured to store a database having a task list having a first task and a second task, and priority score list having a first priority score for the first task and a second priority score for the second task;
a first robot comprising a mobility element configured to move the first robot;
one or a set of processors configured to instruct the first robot to perform a first task; and
wherein at least one of the processors are configured to compare the first priority score to the second priority score, and wherein the system is configured so that when the first priority score is lower ranked than the second priority score, the robot stops the first task and starts the second task.

2. The system of claim 1, wherein the first robot comprises a sensor, and wherein the sensor is configured to detect a signal in the environment of the first robot, and wherein when the sensor detects the signal then the robot transmits at least one of the signal or data representing the signal to at least one of the processors, and wherein the at least one processor is configured to trigger an instruction for the robot system to perform the second task.

3. The system of claim 1, wherein the one or the set of processors comprises a priority engine.

4. The system of claim 3, wherein the priority engine process comprises an interrupt request register configured to receive an instruction for the system to execute a task.

5. The system of claim 3, wherein the priority engine comprises a priority resolver configured to rank tasks at least in part according to the priority scores of the tasks.

6. The system of claim 3, wherein the priority engine comprises an in-service register configured to track tasks currently executed by the system.

7. The system of claim 3, wherein the priority engine comprises an interrupt mask register configured to store a queue of tasks awaiting execution by the system.

8. The system of claim 1, further comprising a server in communication with the first robot, wherein the server comprises at least one of the processors.

9. The system of claim 1, further comprising a second robot in communication with the server, wherein the server is configured to instruct the second robot to perform tasks.

10.-20. (canceled)

21. A roaming sensor system comprising:
a first robot;
a second robot;
a communication network in communication with the first robot and the second robot;
a controller configured to distribute a first task to the first robot and a second task to the second robot, and wherein the controller is configured to monitor a task capacity of the first robot, and wherein when the controller detects that the first robot has capacity for an additional task, the controller is configured to instruct the first robot to perform at least one of all or part of the second task remaining to be performed.

22. The system of claim 21, wherein the first robot comprises a first antenna, and wherein the second robot comprises a second antenna, and wherein the communication network comprises the first antenna and the second antenna.

23. The system of claim 21, further comprising a server, wherein the server comprises the controller, and wherein the server comprises a networking device, and wherein the networking device is in the communication network, and wherein the networking device is in communication with the first robot and the second robot.

24. The system of claim 23, the first robot comprises a first processor

25. The system of claim 23, the second robot comprises a second processor.

26.-40. (canceled)

41. A roaming sensor system comprising:
a first robot;
a server comprising a processor, wherein the server is configured to have data communication with the robot; and
a memory, wherein the memory has data comprising a map of an environment, and wherein the map comprises a map having a zone;
and wherein the server is configured to instruct the robot to follow a first path in the zone at a first time and a second path in the zone at a second time.

42. The system of claim 41, wherein the system is configured to sense wear levels of a floor under the first path and adjacent to the first path, and wherein the system is configured to create the second path based at least in part on the wear levels.

43. The system of claim 41, wherein the system is configured to monitor a security patrol coverage of the first path, and wherein the system is configured to create the second path based at least in part on the security patrol coverage of the first path.

44. The system of claim 41, a second robot, wherein the processor is configured to instruct the second robot to follow a third path in the zone.

45.-46. (canceled)

47. The system of claim 41, further comprising a server, wherein the server comprises the processor and the map, and wherein the server communicates instructions from the processor to the first robot.

48. (canceled)

49. The system of claim 41, further comprising a second robot, wherein the processor is configured to instruct the second robot to follow a third path in the map.

50.-64. (canceled)
